(19) United States
(12) Patent Application Publication
(10) Pub. No.: US 2008/0304836 A1
(43) Pub. Date: Dec. 11, 2008

(54) IMAGE FORMING APPARATUS AND METHOD OF RESTARTING THE APPARATUS

(76) Inventor: Akira TAMAGAKI, Nara-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/133,429

(22) Filed: Jun. 5, 2008

(30) Foreign Application Priority Data
Jun. 8, 2007 (JP) 2007-153371

(51) Int. Cl. G03G 15/20

(52) U.S. Cl. 399/21; 399/68

(57) ABSTRACT

An image forming apparatus which can restrain a flaw from occurring on surfaces of driven members at a time of restarting the apparatus after jam treatment or the like is provided. The image forming apparatus includes a drive load detection section which detects drive load of the respective driven members such as a photoreceptor, a fixing section, a conveyance section and a transfer section driven by a drive section and stops the drives of the respective driven members by the drive section when the drive load detecting section detects the drive load of which value is larger than or equal to a predetermined value at the time of restarting the apparatus.

### CROSS-REFERENCE TO RELATED APPLICATION

This application claims priority to Japanese Patent Application No. 2007-153371, which was filed on Jun. 8, 2007, the contents of which are incorporated herein by reference in its entirety.

### BACKGROUND OF THE INVENTION

1. Field of the Invention

The present invention relates to an image forming apparatus in which image formation is carried out by transferring a toner image formed on an image bearing member, onto a transfer material, and to a method of restarting the apparatus.

2. Description of the Related Art

There have been copy machines and printers as examples of an image forming apparatus in which image formation is carried out by transferring a toner image formed on an image bearing member on a transfer material. In such an image forming apparatus, when continuous image formation is required, a plurality of recording paper sheets as transfer materials are conveyed to a paper conveyance path one by one at predetermined intervals, and are ejected to a paper ejection section after an image has been formed on the recording paper. Paper jam trouble that a recording paper sheet remains on the paper conveyance path sometimes happens during such conveyance of the plurality of recording paper sheets on the paper conveyance path. When the paper jam occurs, the image forming apparatus is immediately stopped and a warning of the paper jam is displayed. Instructed by the warning display, a worker using the image forming apparatus ejects the remaining recording paper sheet on the paper conveyance path (jam treatment), and then the apparatus is restarted. In such a jam treatment like this, the remaining recording paper sheet on the paper conveyance path (jammed paper sheet) which can be seen by the worker can be removed, but a remaining jam paper sheet at a curved paper conveyance path and a torn scrap of a jam paper sheet resulted from removal of the jam paper sheet can not be easily removed easily, and sometimes stay on the paper conveyance path.

FIG. 6 is a view illustrating timings of changes in the respective driven members' rotation speeds when the apparatus to which the related art is applied is restarted. FIG. 7 is a flow chart showing a restarting method of an apparatus to which a related art is applied. The image forming apparatus disclosed in Japanese Unexamined Patent Publication JP-A 9-90824 (1997), to which the related art is applied, comprises a photoreceptor which is an image bearing member which bears an electrostatic latent image thereon, a transfer section which provides the electrostatic latent image with toner and transfers a toner image on a recording paper sheet, a fixing section which fixes the toner image formed on the recording paper sheet, a conveyance section which conveys the recording paper sheet to a fixing location, a drive section which drives the conveyance section or the like, a paper existence detecting section which detects presence or absence of the recording paper sheet on the paper conveyance path and a control section which generally controls the respective sections.

In an image forming apparatuses disclosed in JP-A 9-90824, when the paper jam occurs, the apparatus is stopped and a warning of the paper jam is displayed in Step a0. Next, in Step a1, a worker opens a front door of the image forming apparatus and makes the jam treatment by removing a jam paper sheet which is a remaining recording paper sheet on the paper conveyance path. When the worker judges that the jam treatment is made, the worker closes the front door and the step proceeds to Step a2. In Step a2, a signal indicating whether the front door is closed or not is given to the control section by an opening and closing detecting sensor disposed near the front door, and the step proceeds to Step a3 when the control section judges that the front door is closed. When the control section judges that the front door is not closed in Step a2, Step a2 is repeated until the front door is closed.

In Step a3, the control section gives the drive section a drive instruction and makes the respective driven members such as the photoreceptor, the transfer section, the fixing section, the conveyance section or the like rotate. The respective driven members generally rotate at a rotation speed S₂ as shown in FIG. 6. The normal rotation denotes a rotation which the respective driven members make when the image forming apparatus forms the image on the recording paper sheet. Next, in Step a4, a signal indicating whether there is no remaining jam paper sheet on the paper conveyance path is given to the control section by the paper existence detecting section, and the step proceeds to Step a5 when the control section judges that there is no remaining jammed paper sheet. When the control section judges that there is a remaining jammed paper sheet in Step a4, the control section stops the apparatus immediately, displays the warning of the paper jam and returns to Step a1. In this step, the photoreceptor, for example rotates a plurality of times with the jammed paper sheet tangled up. Therefore, the photoreceptor bears drive load.

In Step a5, a signal indicating whether predetermined period of rotation has elapsed or not is given to the control section by the drive section, and the step proceeds to Step a6 when the control section judges that the setting period of rotation has elapsed. When the control section judges that the predetermined period does not elapse, Step a5 is repeated until the period elapses. In Step a6, the control section gives the drive section an instruction to stop the rotation of the conveyance section. Then, the rotation speed of the conveyance section becomes zero as shown in FIG. 6. Next, in Step a7, the a signal indicating whether surface temperature of a heating roller of the fixing section is within an allowable range or not is given to the control section by the fixing section, and the step proceeds to Step a8 when the control section judges that the surface temperature is within the allowable range. When the control section judges that the surface temperature of the heating roller is not within the allowable range in Step a7, Step a7 is repeated until the temperature comes to be within the allowable range.

In Step a8, the control section gives the drive section an instruction to stop the rotation of the fixing section. Then, the rotation speed of the fixing section becomes zero as shown in FIG. 6. Next, in Step a9, a signal indicating whether initialization of the photoreceptor is made or not is given to the control section by the photoreceptor, and the step proceeds to Step a10 when the control section judges that the initialization is made. When the control section judges that the initialization of the photoreceptor is not made in Step a9, Step a9 is repeated until the initialization is made. In Step a10, the control section gives the drive section an instruction to stop the rotation of the photoreceptor and the transfer section. Then, the rotation speed of the photoreceptor and the transfer section becomes zero as shown in FIG. 6. Next, in Step a11, the image forming apparatus displays an indication showing that the image formation is enabled, the step proceeds to Step 12 and finishes a restarting action of the apparatus.

In the image forming apparatus disclosed in JP-A 9-90824, during a processing of restarting the apparatus after the jam treatment, a paper existence detecting section detects the remaining jammed paper sheet on the paper conveyance path without perfecting the jam treatment with the drive section rotating the driven members such as the photoreceptor or the like. Therefore, based on this detection result, the remaining jammed paper sheet on the paper conveyance path can be removed without perfecting the jam treatment. However, the jammed paper sheet is sometimes tangled up in the rotating driven members or the like when the paper existence detecting section detects the jammed paper sheet. The driven members rotate a plurality of times with the jammed paper sheet tangled up and they bear the drive load. The surfaces of the driven members which has borne the drive load receive a flaw in the parts where the tangled jammed paper sheet touches the surfaces. Such a flaw on the surfaces of the driven members not only causes deterioration in quality of the image formed on the recording paper, but also shortens service lives of the driven members.

### SUMMARY OF THE INVENTION

An object of the invention is to provide an image forming apparatus which can restrain a flaw from occurring on surfaces of driven members and a method of restarting the image forming apparatus.

The invention provides an image forming apparatus comprising:

an image bearing member which bears an electrostatic latent image thereon;

a transfer section which supplies toner to the electrostatic latent image formed on the image bearing member and transfers a toner image onto a transfer material;

a fixing section which fixes the toner image formed on the transfer material;

a conveyance section which conveys the transfer material to the fixing position;

a drive section which drives driven members including the image bearing member, the transfer section, the fixing section and the conveyance section; and

a drive load detecting section which detects drive load of the respective driven members driven by the drive section,

the drive section stopping drives of the respective driven members at a time when the drive load detecting section detects a drive load of which value is greater than or equal to a predetermined load value, when a predetermined condition is fulfilled.

According to the invention, at the time of restarting the apparatus after jam treatment, when a remaining jammed paper sheet as a transfer material is tangled up in the respective driven members including the image bearing member, the transfer section, the fixing section and the conveyance section, the drive load detecting section detects the drive load of the respective driven members and stops the drives of the respective driven members. Accordingly, the rotation of the respective driven members under the condition that the jammed paper sheet is tangled up and that the respective driven members bear the drive load can be prevented and occurrence of the flaw on the surfaces of the driven members which the jammed paper sheet touches can be also prevented.

Further, in the invention, it is preferable that the image forming apparatus comprises a transfer material existence detecting section which detects presence or absence of the transfer material on a paper conveyance path on which the conveyance section conveys the transfer material, and the drive section stops driving of the respective driven members by the drive section when the drive load detecting section detects the drive load of which value is greater than or equal to the predetermined load value and the transfer material existence detecting section detects the transfer material at the time of restarting the apparatus.

According to the invention, the image forming apparatus comprises a transfer material existence detecting section which detects presence or absence of the transfer material on the paper conveyance path on which the conveyance section conveys the transfer material. When a jammed paper sheet remains on the paper conveyance path at the time of restarting the apparatus after the jam treatment, the remaining jammed paper sheet on the paper conveyance path can be detected more reliably. This is because not only the drive load detecting section but also the transfer material existence detecting section detects the jammed paper sheet.

Further, in the invention, it is preferable that, in rotation speeds of the respective driven members rotated by the drive section, the rotation speed when the drive load detecting section detects the drive load and when the transfer material existence detecting section detects the transfer material is smaller than the rotation speed when the image is formed on the transfer material.

According to the invention, with respect to the rotation speed of the respective driven members rotated by the drive section, the rotation speed when the drive load detecting section detects the drive load and when the transfer material existence detecting section detects the transfer material is smaller than the rotation speed when the image is formed on the transfer material. Under the condition that the respective driven members rotate at such rotation speed in detecting, the drive load detecting section detects the drive load of the respective driven members, so that the detection of the respective driven members can be made at full.

Further, in the invention, it is preferable that the drives of the respective driven members by the drive section are stopped and a warning is displayed when the drive load detecting section detects the drive load of which value is greater than or equal to the predetermined value and when the transfer material existence detecting section detects the transfer material at the time of restarting the apparatus.

According to invention, the image forming apparatus stops the drive of the respective driven members by the drive section and displays a warning, when the drive load detecting section detects the drive load of which value is greater than or equal to the predetermined load value. Thus the image forming apparatus displays such a warning, so that the worker can remove the remaining jammed paper sheet on the paper conveyance path.

Further, in the invention, it is preferable that detection actions of the drive load detecting section and the transfer material existence detecting section in a state where a predetermined condition is fulfilled are taken at a time of warm-up when energization to the apparatus restarts and at a time of recovery from power saving mode after the jam treatment is made by removing the remaining transfer material on the paper conveyance path.

According to the invention, detection actions of the drive load detecting section and the transfer material existence detecting section in a state that the predetermined condition is fulfilled are taken at a time of the warm-up when the energization to the apparatus restarts and at a time of the recovery from the power saving mode after the jam treatment is made by removing the remaining transfer material on the paper conveyance path. The jammed paper can be removed before the main processing of forming the image on the transfer material is executed, since the respective detecting sections detect whether the transfer material remains on the paper conveyance path or not at the time of the warm-up and the recovery from the power saving mode after the jam treatment.

Further, the invention provides a method of restarting the image forming apparatus which forms the image by transferring the toner image formed on the image bearing member on the transfer material, comprising:

a drive load detection step of detecting drive load of a plurality of rotating driven members; and

a transfer material existence detection step of detecting presence or absence of the transfer material on a paper conveyance path on which the transfer material is conveyed.

According to the invention, the method of restarting the image forming apparatus which forms the image by transferring the toner image formed on the image bearing member on the transfer material comprises a drive load detection step of detecting drive load of respective driven members and a transfer material existence detection step of detecting presence or absence of the transfer material on a paper conveyance path on which the transfer material is conveyed. In case where the apparatus restarts after the jam treatment and that the jammed paper sheet as the transfer material remains on the paper conveyance path and is tangled up in the respective driven members, the drive load of the respective members is detected in the drive load detection processing, and therefore the drives of the driven members can be stopped based on detection results when the driven members bear the drive load. Accordingly, the occurrence of flaw on the surfaces of the driven members which the jammed paper sheet touches can be restrained. Moreover, probability that the jammed paper sheet remains on the paper conveyance path without being detected can be reduced since the presence or absence of the jammed paper sheet on the paper conveyance path is detected in the transfer material existence detection processing.

Further, in the invention, it is preferable that the rotation speeds of the respective driven members in the drive load detection step and the transfer material existence detection step are smaller than the rotation speeds of the respective driven members when the image is formed on the transfer material.

According to the invention, the rotation speeds of the respective driven members in the drive load detection step and the transfer material existence detection step are smaller than the rotation speeds of the respective driven members when the image is formed on the transfer material. The drive load of the respective driven members can be detected at full since the detection is made in a state where the respective driven members rotate at a rotation speed during detection.

Further, in the invention, it is preferable that a rotation speed during detection is set to be half or lower than a rotation speed during image formation.

According to the invention, the rotation speed during detection is set to be half or lower than the rotation speed during image formation. Therefore, the drive load of the respective driven members can be detected more reliably.

Further, in the invention, it is preferable that a setting period of the drive load detection step and the transfer material existence detection step is set to a period during which all of the plurality of driven members finish rotating once.

According to the invention, the setting period of the drive load detection step and the transfer material existence detection step is set to the period during which all of the plurality of driven members finish rotating once. Therefore, the drive load of the respective driven members can be detected more reliably during the period of single rotation of the respective driven members.

### BRIEF DESCRIPTION OF THE DRAWINGS

Objects, features, and advantages of the invention will be more explicit from the following detailed description taken with reference to the drawings wherein:

FIG. 1 is a view illustrating arrangement of the drive load detecting section and the transfer material existence detecting section;

FIG. 2 is a cross sectional side view illustrating the constitution of the image forming apparatus;

FIG. 3 is a view illustrating timings of changes in rotation speeds of respective driven members at a time of restarting an apparatus according to the first embodiment of the invention;

FIGS. 4A and 4B are flow charts each showing a method of restarting the apparatus according to the first embodiment of the invention;

FIG. 5 is a view illustrating timings of changes in rotation speeds of respective driven members at a time of restarting an apparatus according to a second embodiment of the invention;

FIG. 6 is a view illustrating timings of changes in rotation speeds of respective driven members at a time of restarting an apparatus to which a related art is applied; and

FIG. 7 is a flow chart showing a method of restarting an apparatus to which a related art is applied.

### DETAILED DESCRIPTION

Now referring to the drawings, preferred embodiments of the invention are described below.

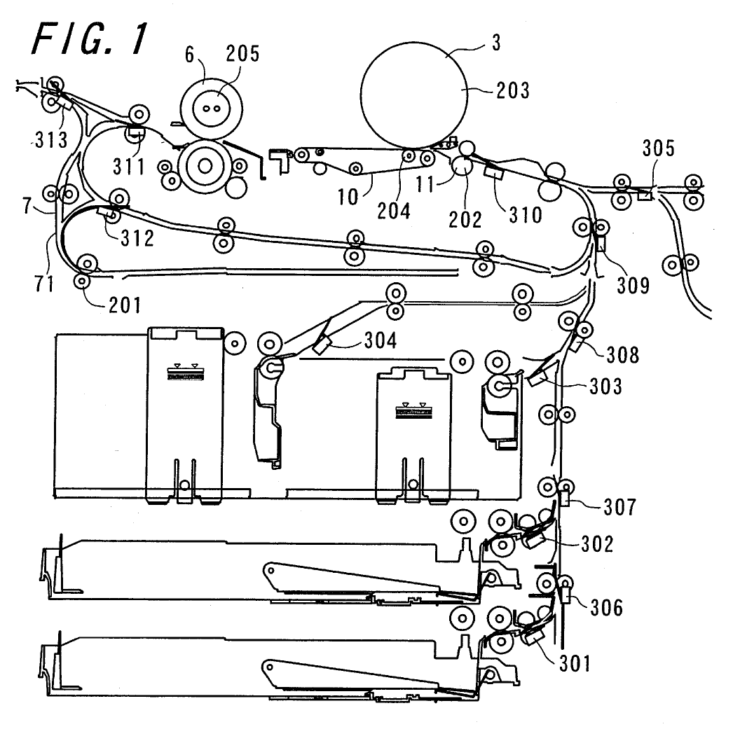

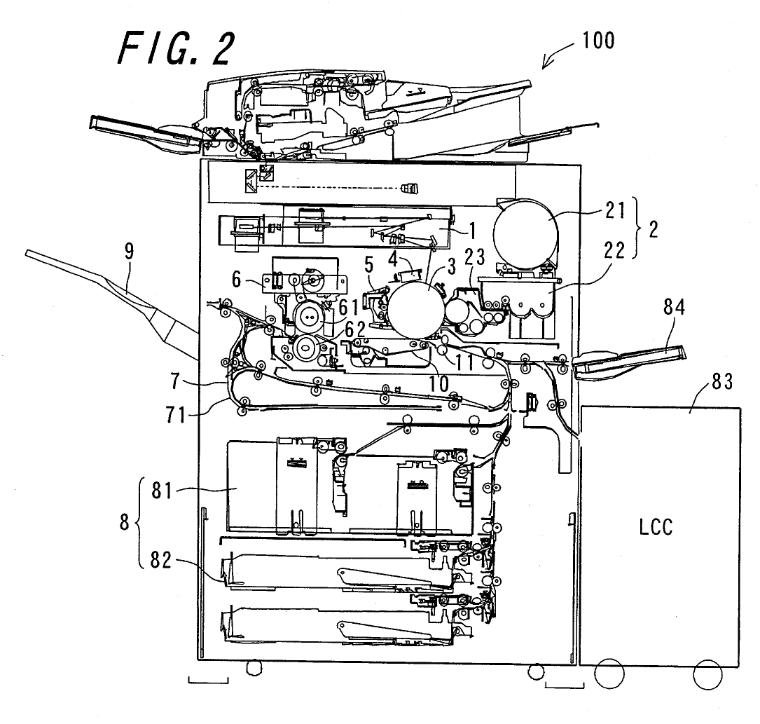

FIG. 1 is the view illustrating the arrangement of a drive load detecting section and a transfer material existence detecting section. FIG. 2 is the cross sectional side view illustrating the constitution of the image forming apparatus 100. The image forming apparatus 100 is an apparatus forming a monochrome image on a prescribed transfer material (recording paper) in accordance with image data transmitted from outside under high-speed image formation processing. The image forming apparatus 100 comprises a drive load detecting section which detects the drive load of the driven members rotated by the drive section and a transfer material existence detecting section which detects the presence or absence of the recording paper conveyed by a conveyance section 7 on a paper conveyance path 71 as will hereinafter described in detail.

The image forming apparatus 100 comprises a photoreceptor 3 which is an image bearing member, a charging section 4, an exposure section 1, a developing section 2, a transfer section 10, a cleaning section 5, a fixing section 6 and a conveyance section 7, as shown in FIG. 2. Moreover, the image forming apparatus 100 comprises the drive section (not shown) which rotates the respective driven members such as the photoreceptor 3, the transfer section 10, the fixing section 6 and the conveyance section 7.

The photoreceptor 3 is the image bearing member which bears an electrostatic latent image thereon, is supported by the drive section in a way that the photoreceptor can rotate about an axis line thereof, and comprises a cylindrical conductive substrate (not shown) and a photosensitive layer formed on a surface of the conductive substrate. The photoreceptor 3 can be made of materials which are normally used in this area. For example, a photoreceptor drum of 30 mm to 100 mm in diameter comprising an aluminum pipe stock as a conductive substrate and an organic photosensitive layer formed on the surface of the aluminum pipe stock is used. The organic photosensitive layer is made from lamination of a charge generating layer containing a charge generating substance and a charge transporting layer containing a charge transporting substance. The organic photosensitive layer containing the charge generating substance and the charge transporting substance within one layer can also be used.

The surface of the photoreceptor 3 is charged by the charging section 4 uniformly to an electric potential of a predetermined polarity. Although the charging section 4 can be a contact-roller-type or contact-brush-type charging section, in the embodiment of the invention the charging section 4 is a charger-type charging section. A laser scanning unit (LSU) equipped with an irradiation portion and a reflection mirror is used for the exposure section 1. In the image forming apparatus 100 of the embodiment, a two-beam method is adopted for a purpose of high-speed image formation processing so that a timing of irradiation is speeded up by using a plurality of laser light beams. By exposing the photoreceptor 3 to which is charged uniformly by the charging section 4 in accordance with inputted image data, the exposure section 1 forms the electrostatic latent image on the surface of the photoreceptor 3 in accordance with the image data. The method of the exposure section is not limited to use of LSU, but use of an EL or LED writing head with light-emitting elements arranged in an array can be also used for the exposure section 1.

The developing section 2 develops the electrostatic latent image formed on the photoreceptor 3 by black toner as a developer. The developing section 2 comprises a developer tank 23, a toner precharge box 22 and a toner replenishment box 21. The developer tank 23 comprises a developing roller which supplies toner to the photoreceptor 3, a layer thickness regulation member which regulates thickness of a toner layer formed on an outer circumferential surface of the developing roller, and an agitating supply roller which supplies toner to the developing roller in the developer tank 23. In the image forming apparatus 100, toner is once transferred from the toner replenishment box 21 to the toner precharge box 22, preliminarily charged in the toner precharge box 22, and the precharged toner is replenished from the toner precharge box 22 to the developer tank 34.

The transfer section 10 transfers the toner image on the recording paper conveyed by the conveyance section 7 (as will be described later) by applying an electric field whose polarity is reverse to that of an electric charge of the toner image, to the toner image which is the visualized electrostatic image developed on the photoreceptor 3. For example, when the toner image includes an electric charge of negative polarity, the applied polarity of the transfer section 10 is positive polarity. The transfer section 10 comprises a driven roller, an elastic conductive roller, and a transfer belt which is stretched between the driven roller and another roller and has resistance in a range roughly from 1×10⁹ to 1×10¹³ Ω·cm. The transfer belt is a driven member rotated by the drive section. While conveying the recording paper on which the toner image is formed by the transfer belt, the transfer section 10 transfers the toner image on the recording paper from the photoreceptor 3, by applying the transfer electric field of which polarity is reverse to that of the electric charge of the toner image.

A surface of the elastic conductive roller has elasticity. Therefore, the photoreceptor 3 and the transfer belt are not in liner contact but in face contact with a predetermined width (called a transfer nip), and it is possible to improve transfer efficiency on the recording paper. On the downstream side of the course in which the recording paper is conveyed by the transfer belt, an electric charge removing roller is also disposed on the back of the transfer belt. The electric charge removing roller removes the electric field applied to the recording paper by the transfer section 10 and smoothen conveyance to the next processing. A cleaning unit and an electric charge removing unit which removes an electric charge of the transfer belt are also disposed in the transfer section 10. As for a method of removing an electric charge by the electric charge removing unit, there are a method of grounding the transfer belt through the apparatus, a method of applying an electric charge of which polarity is reverse to the transfer electric field applied to the elastic conductive roller, or the like. With respect to a rotation direction, the cleaning section 5 is disposed on the downstream side of the transfer section 10, removes and recovers toner which can not be transferred on the recording paper from the photoreceptor 3 by a transfer action, namely, the remaining toner from the surface of the photoreceptor 3.

The fixing section 6 melts unfixed toner which is the toner image transferred on the recording paper by the transfer section 10 and fixes the toner image on the recording paper. The fixing section 6 comprises a heating roller 61 and a pressure roller 62 which are driven members rotated about an axis line by the drive section. In the embodiment of the invention, diameters of the heating roller 61 and the pressure roller 62 are set to 30 mm through 60 mm. Inside the heating roller 61, a heat source is disposed which heats up the surface of the heating roller to a fixing temperature of about 160° C. through 200° C. Also, a paper peeling claw which peels the recording paper winding around the heating roller 61, a roller surface temperature detecting member (a thermistor) which detects the surface temperature of the heating roller 61 and a roller surface cleaning member which cleans the surface of the heating roller 61 are disposed on the surface of the heating roller 61.

At both of the ends of the pressure roller 62, a pressing member is disposed which presses the pressure roller 62 against the heating roller 61 by predetermined pressure. Also, on the surface of the pressure roller 62, disposed are the paper peeling claw which peels the recording paper winding around the pressure roller 62 and the roller surface cleaning member which cleans the surface of the pressure roller 62. The fixing section 6 passes the recording paper on which the toner image is transferred through a pressure-contact area formed by the heating roller 61 and the pressure roller 62 (called a fixing nip), and fixes the toner image on the recording paper through a heating and melting action of the toner image by the heating roller 61 and an anchoring action of the toner image on the recording paper by the pressure roller 62.

The conveyance section 7 is a mechanism for conveying the recording paper from a paper feeding tray 8 to a paper ejection tray 9 on a paper conveyance path 71. The paper conveyance path 71 is a path for feeding the recording paper from the paper feeding tray 8 and for conveying the recording paper on which the image is formed and fixed to the paper ejection tray 9. Also, the paper conveyance path 71 includes a switchback conveyance path and a reverse conveyance path which are paths for conveying the recording paper when images are formed on both sides of the recording paper. The conveyance section 7 includes a conveyance roller which is a driven member rotated about an axis line by the drive section. In the embodiment of the invention, a diameter of the conveyance roller is limited to 6 mm through 16 mm. A plurality of conveyance rollers are disposed on the paper conveyance path 71 in such a way that a pair of the rollers press against and come into contact with each other. The recording paper is conveyed on the paper conveyance path 71 by passing through a nip which is a pressure-contact area formed by the pair of the rotated conveyance rollers.

The paper feeding tray 8 is a tray for storing and sending out the recording paper sheets and is disposed in a lower part and a side wall face of the apparatus. The image forming apparatus 100 of the embodiment is aimed at high-speed image formation processing, so the paper feeding tray 8 disposed in the lower part of the apparatus is composed of a plurality of trays which can contain 500 through 1500 sheets of the regular size recording paper sheets. In the embodiment of the invention, two of a first automatic paper feeding tray 81 and a second automatic paper feeding tray 82 are disposed in a lower part of the apparatus. Also, on the side wall face of the apparatus, a large capacity container (LCC) 83 which can contain a great deal of the recording paper sheets of a plurality of sizes and a manual feeding tray 84 which mainly contains the recording paper sheets of irregular sizes are disposed. The paper ejection tray 9 is disposed on the opposite side wall face of the manual feeding tray 84. In addition, instead of the paper ejection tray 9, a posterior processing apparatus (an apparatus for stapling, punching and so on) for an ejected recording paper and a multiple-stage paper ejection tray can be disposed as an optional extra.

Moreover, the image forming apparatus 100 comprises a registration roller 11 which positions the recording paper before the toner image formed on the photoreceptor 3 is transferred on the recording paper by the transfer section 10. The recording paper which is conveyed from the paper feeding tray 8 to the paper conveyance path 71 by the conveyance section 7 collides with a nip of the registration roller 11 in resting state, and the leading edge of the recording paper is positioned. After the positioning of the recording paper is finished, the registration roller 11 is rotated about an axis line thereof by the drive section. Accordingly, the recording paper is conveyed in the direction of the photoreceptor 3. In the embodiment of the invention, a diameter of the registration roller 11 is set to 6 mm through 16 mm.

In the image forming apparatus 100, when continuous image formation is required, a plurality of recording paper sheets are conveyed one by one at predetermined intervals from the paper feeding tray 8 to the paper conveyance path 71 by the conveyance section 7, and are ejected to the paper ejection tray 9 after the images are formed on the recording paper sheets. The intervals of the recording paper sheets at a time of conveying the recording paper sheets to the paper conveyance path 71 by the conveyance section 7 depend on the number of recording paper sheets on which an image is to be formed and processed per unit time (one minute) and processing speed of image formation on the recording paper. The intervals of the recording paper are set to about 30 through 100 mm, and becomes smaller as the image formation processing speed becomes higher. And then, the respective driven members such as the photoreceptor 3, the fixing section 6, conveyance section 7, the transfer section 10 and the registration roller 11 are rotated by the drive section.

The image forming apparatus 100 comprises the drive load detecting section which detects the drive load of the driven members rotated by the drive section and the transfer material existence detecting section which detects the presence or absence of the recording paper on the paper conveyance path 71, as shown in the FIG. 1. The drive load detecting section comprises a conveyance drive load detecting sensor 201, a registration drive load detecting sensor 202, a photoreceptor drive load sensor 203, a transfer drive load detecting sensor 204 and a fixing drive load detecting sensor 205.

The transfer drive load detecting sensor 201 is a driven member of the conveyance section 7, and a sensor which detects drive load exerted on a rotation shaft of the conveyance roller at a time when the plurality of conveyance rollers disposed on the paper conveyance path 71 are rotated. The registration drive load detecting sensor 202 is a sensor which detects drive load exerted on a rotation shaft of the registration roller 11 at a time when the registration roller 11 is rotated. The photoreceptor drive load detecting sensor 203 is a sensor which detects drive load exerted on a rotation shaft of the photoreceptor 3 at a time when the photoreceptor 3 is rotated. The transfer drive load detecting sensor 204 is a sensor which detects drive load exerted on a rotation shaft of the transfer belt which is a driven member of the transfer section 10 at a time of the transfer belt is rotated. The fixing drive load detecting sensor 205 is a sensor which detects drive load exerted on rotation shafts of the heating roller 61 and the pressure roller 62 which are driven members of the fixing section 6 at a time when the heating roller 61 and the pressure roller 62 are rotated. The drive load detecting sections which detect the drive load of the respective driven members are disposed on a harness line connected to a drive source which rotationally drives the respective driven members, and is constituted by a device which detects consumption current of the drive source, for example, an ammeter with a limiter.

(Setting Value of Drive Load)

The drive load detecting section detects the drive load of the respective driven members at the time of the warm-up when the energization to the apparatus restarts and the recovery from the power saving mode or the like, after the jam treatment is made by removing the remaining jammed paper sheet on the paper conveyance path 71 due to occurrence of the paper jam. The image forming apparatus 100 is configured to judge whether there is no remaining jammed paper sheet on the paper conveyance path 71 by comparing a normal drive load value which is a drive load value when there in no jammed paper sheet tangled up in the respective driven members with a restarting drive load value which is a drive load value at the time of restarting the apparatus, with reference to drive load values of the respective driven members detected by the drive load detecting section. Therefore, it is judged whether there is a remaining jammed paper sheet by only such detection of drive load of the respective driven members of the drive load detecting section, and thereby control can be simplified. In addition, the image forming apparatus 100 is configured to stop the rotational drives of the respective driven members when the image forming apparatus judges that there is the remaining jammed paper sheet. In the embodiment of the invention, the image forming apparatus 100 is configured to judge that there is the remaining jammed paper sheet on the paper conveyance path 71 when the restarting drive load value becomes 1.2 through 1.5 times larger than the normal drive load value.

In this way, the image forming apparatus 100 is configured in such a way that the rotational drives of the driven members are stopped when the respective driven members tangle up the jammed paper sheet at the time of restarting the apparatus and thereby bear drive load, and therefore the occurrence of the flaw on the surface of the driven members which the jammed paper sheet touches can be restrained. In addition, since the drive load detecting section detects the drive load of the respective driven members at the time of the warm-up and the recovery from the power saving mode after the jam treatment, based on the detection result, the jammed paper sheet can be removed before the image formation processing for forming the image on the recording paper is executed.

The image forming apparatus 100 can be configured to display a warning as well as to stop the rotational drives of the driven members when the drive load detecting section detects the drive load of which value is greater than or equal to the drive load value. The display of the warning is to inform the worker operating the image forming apparatus 100 of the fact that the jammed paper sheet is remaining on the paper conveyance path 71, and, for example, it is sufficient that an indication of “occurrence of paper jam” is displayed on an operation panel through which the worker operates the apparatus. Since the image forming apparatus 100 displays a warning in this way, the worker can perform an action of removing the remaining jammed paper sheet on the paper conveyance path 71.

(Rotation Speeds of Driven Members)

Rotation speeds of the respective driven members are set, considering paper conveyance speed which is speed at which the recording paper is conveyed. Rotation speed during image formation which is rotation speed at which the image is formed on the recording paper is set in such a way that image formation paper conveyance speed which is paper conveyance speed at a time of image formation is limited within a range shown in the following formula (1).

1.5×C≦A≦2.0×C (1)

[Where, A denotes an image formation paper conveyance speed (mm/sec), and C denotes an image formation processing speed which is speed at which the image is formed on the recording paper (mm/sec).]

Reasons why the image formation paper conveyance speed is set higher than the image formation processing speed are to secure time for positioning of the recording paper by the registration roller 11 and for the posterior processing of the ejected recording paper (punching processing, stapling processing or the like).

Rotation speed during detection which is a rotation speed at a time when the drive load detecting section detects the drive load of the respective driven members at the time of restarting the apparatus is restarted is set in such a way that detection paper conveyance speed which is paper conveyance speed during drive load detection is limited within a range shown in the following formula (2).

0.9×C≦B≦1.1×C (2)

[Where B denotes a detection paper conveyance speed (mm/sec), and C denotes an image formation processing speed at which the image is formed on the recording paper(mm/sec).]

As evidenced by the formulae (1) and (2), the detection paper conveyance speed is smaller than the image formation paper conveyance speed. In other words, the rotation speed during detection is set to be smaller than the rotation speed during image formation. From the formulae (1) and (2), the rotation speed during detection and the rotation speed during image formation is in such a relation as shown in the following formula (3).

0.45×E≦D≦0.73×E (3)

[Where D denotes a rotation speed during detection (mm/sec), and E denotes an rotation speed during image formation (mm/sec).]

Since the drive load detection section detects the drive load of the respective driven members under the condition that the respective driven members are rotating at the rotation speed during detection, the drive load of the respective driven members can be detected at full. Moreover, it is recommended that the rotation speed during detection is set to be smaller than or equal to half the rotation speed during image formation. In other words, considering the formula (3), the rotation speed during detection and the rotation speed during image formation are preferably in such a relationship as shown in the following formula (4). The drive load detecting section can detect the drive load of the respective driven members more reliably by setting the rotation speed in this way.

0.45×E≦D≦0.50×E (4)

[Where D denotes a rotation speed during detection (mm/sec), and E denotes a rotation speed during image formation (mm/sec).]

(Setting Period of Rotation of Respective Driven Members at Time of Drive Load Detection)

The drive load detecting section can detect the drive load of the respective driven members while the respective driven members rotate once. Therefore, the setting period of rotation of the respective driven members is set to the period when the respective driven members rotate once, in consideration of the outer circumferential length of the respective driven members. For example, the conveyance roller of which diameter is 6 to 16 mm rotates once in a shorter time than the photoreceptor 3 of which diameter is 30 to 100 mm, so the setting period of the rotation of the conveyance roller is set to be shorter than that of the photoreceptor 3.

The transfer material existence detecting section comprises paper entering detecting sensors 301, 303, 304 and 305, paper conveyance path detecting sensors 306, 307, 308, 309, 310 and 311, a reverse conveyance path detecting sensor 312 and a paper ejection detecting sensor 313, as shown in FIG. 1. The paper entering detecting sensor is a sensor detecting whether the recording paper normally enters the paper conveyance path 71 from the paper feeding tray and whether the recording paper enters the paper conveyance path 71 at appropriate intervals. The paper conveyance path detecting sensor is a sensor which detects whether the recording paper which enters the paper conveyance path 71 is normally conveyed toward the photoreceptor 3 on the paper conveyance path 71. The reverse conveyance path detecting sensor is a sensor detecting whether the recording paper is normally conveyed on the switchback conveyance path and the reverse conveyance path. The paper ejection detecting sensor is a sensor detecting whether the recording paper conveyed on the paper conveyance path 71 is normally ejected from the paper ejection tray 9.

While the recording paper is conveyed on the paper conveyance path 71, the transfer material existence detecting section detects at which part of the paper conveyance path 71 the recording paper is conveyed and whether the recording paper reaches the transfer material existence detecting section within the predetermined period. The image forming apparatus 100 judges that there is the paper jam occurence when the recording paper does not reach the transfer material existence detecting section.

Moreover the transfer material existence detection section detects the presence or absence of the remaining jammed paper sheet on the paper conveyance path 71 when the drive load detecting section detects the drive load of the respective driven members. Since not only the drive load detecting section but also the transfer material existence detecting section detects the jammed paper sheet when the jammed paper sheet remains on the paper conveyance path 71 at the time of restarting the apparatus, the remaining jammed paper sheet on the paper conveyance path 71 can be detected more reliably.

In addition, the image forming apparatus 100 includes a control section (not shown). The control section comprises a storage portion, a computing portion and an input/output portion. The storage portion stores control programs for controlling controlled objects such as the drive section, the fixing section 6, the conveyance section 7 and the transfer section 10. The computing portion reads out the control program which is stored in the storage portion and outputs computed results according to the control program. The input/output portion gives various kinds of instruction values according to the computed results from the computing portion. The input/output portion gives information given by the controlled object and the signals given by the drive load detecting section, the transfer material existence detecting section and the like.

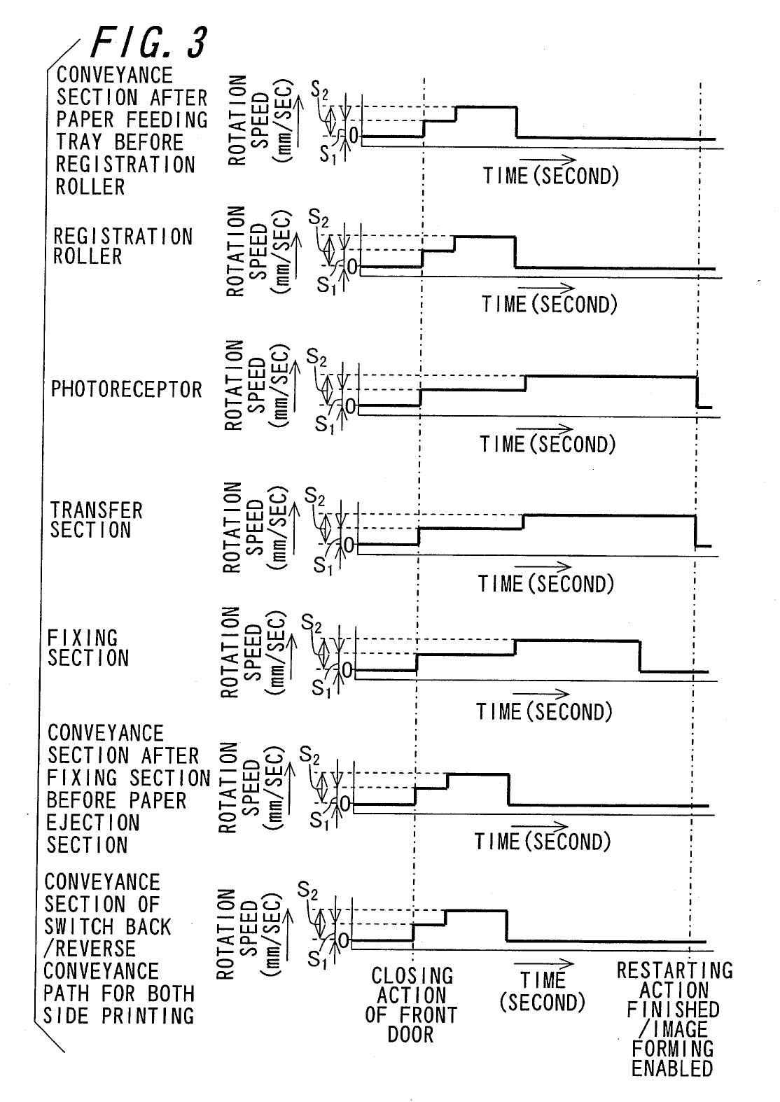

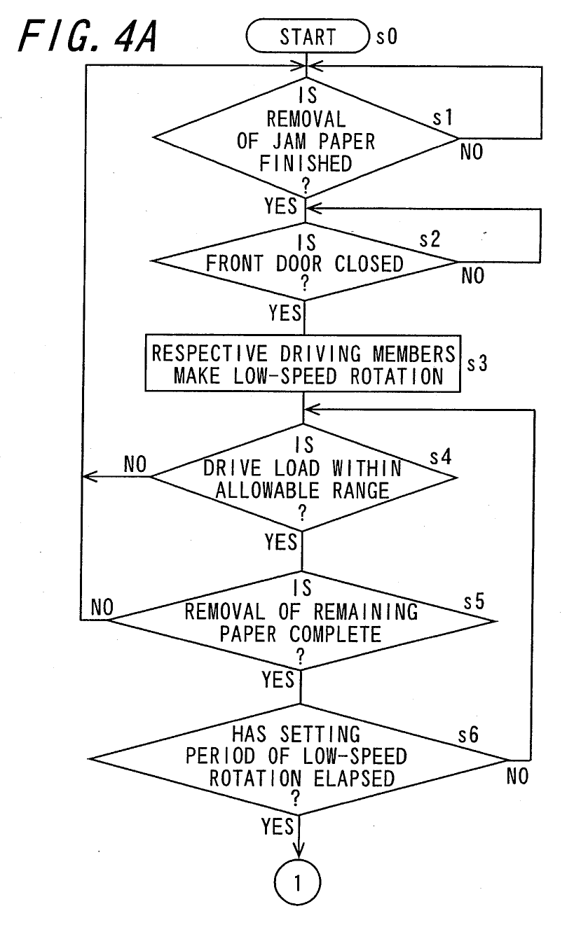

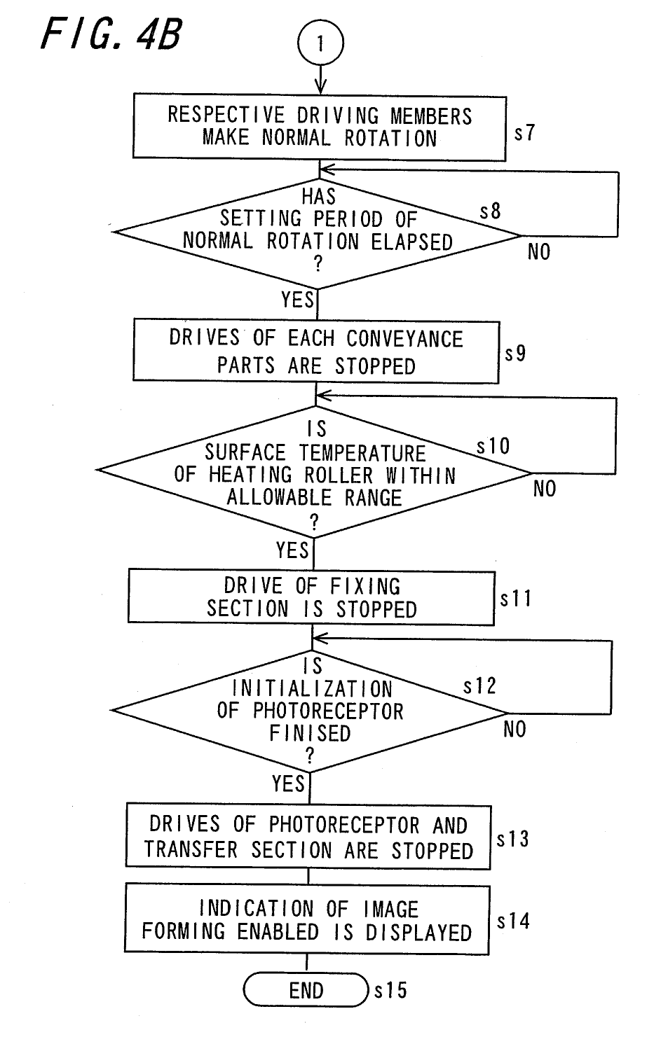

FIG. 3 is the view illustrating the timings of the changes in the rotation speeds of the respective driven members at the time of restarting the apparatus according to the first embodiment of the invention. FIGS. 4A and 4B are flow charts each showing the method of restarting the apparatus according to the first embodiment of the invention. When the paper jam occurs, the image forming apparatus 100 is stopped and the warning of the paper jam is displayed in Step s0. Next, in Step s1, the worker opens the front door of the image forming apparatus 100 and makes the jam treatment by removing the jammed paper sheet which is the remaining recording paper on the paper conveyance path 71. When the worker judges that the jam treatment is made, the worker closes the front door and the step proceeds to Step a2. In Step s2, a signal indicating whether the front door is closed or not is given to the control section by an opening and closing detecting sensor disposed near the front door, and the step proceeds to Step s3 when the control section judges that the front door is closed. When the control section judges that the front door is not closed in Step s2, Steps s2 is repeated until the front door is closed.

In Step s3, the control section gives the drive section a drive instruction at low speed and makes the respective driven members such as the photoreceptor 3, the transfer section 10, the fixing section 6, the conveyance section 7 or the like rotate. The respective driven members make low-speed rotation at a rotation speed S1 as shown in FIG. 3. The low-speed rotation denotes a rotation of which speed is half the rotation speed during image formation when the image forming apparatus 100 forms the image on the recording paper. Next, in Step s4, a signal indicating whether the drive load of the respective driven members is within the allowable range is given to the control section by the drive load detecting section, and the control section conducts the drive load detection step. The step proceeds to Step s5 when the control section judges that the drive load is not within the allowable range. In the drive load detection step, the drive load of the respective driven members can be detected reliably since the drive load detecting section detects the drive load while the respective driven members make the low-speed rotation.

When the control section judges that the drive load is not within the allowable range in Step s4, the apparatus is stopped urgently, displays a warning of the occurrence of the paper jam and returns to Step s1. In the drive load detecting section, the occurrence of the flaw on the surface of the driven members which the jammed paper sheet touches can be prevented, since, when the driven members such as the photoreceptor 3 tangle up the jammed paper sheet and bears the drive load, the drives of the driven members are stopped. Therefore, deterioration in quality of the image formed on the recording paper can be prevented and the service lives of the driven members can be lengthened.

In Step s5, a signal indicating whether there is no remaining jam paper on the paper conveyance path 71 is given to the control section by the transfer material existence detecting section, and the control section conducts the transfer material existence detection step. The step proceeds to Step s6 when the control section judges that there is no remaining jammed paper sheet. When the control section judges that there is the remaining paper in Step s5, the apparatus is stopped urgently, displays the warning of the occurrence of the paper jam and returns to the s1. Probability that the jammed paper sheet remains on the paper conveyance path without being detected can be reduced since the transfer material existence detecting section in addition to the drive load detecting section detects the jammed paper sheet on the paper conveyance path in the transfer material existence detection step.

In Step s6, a signal indicating whether predetermined period of the low-speed rotation in the drive load detection step and the transfer material existence detection step has elapsed or not is given to the control section by the drive section, and the step proceeds to Step s7 when the control section judges that the predetermined period of rotation has elapsed. The predetermined period is set to a period during which the respective driven members rotate once. By setting the period of the low-speed rotation in this way, the drive load of the respective driven members can be detected reliably while the respective driven members rotate once. When the control section judges that the setting period of rotation does not elapse in Step s6, Step s6 is repeated until the setting period elapses.

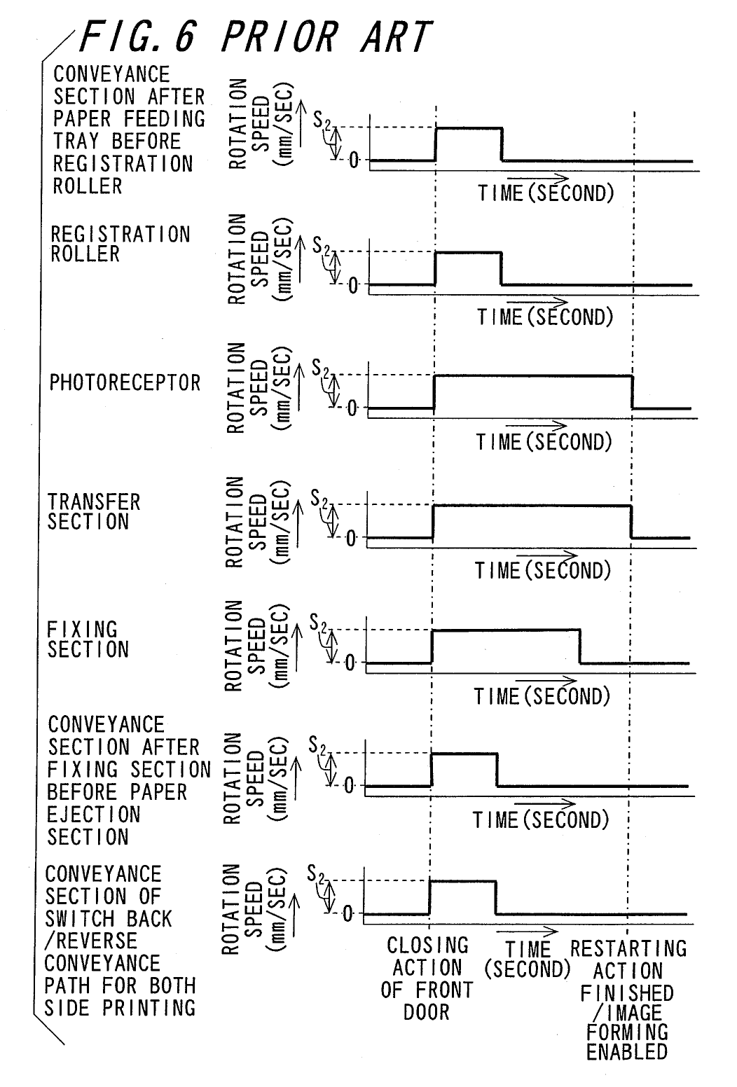

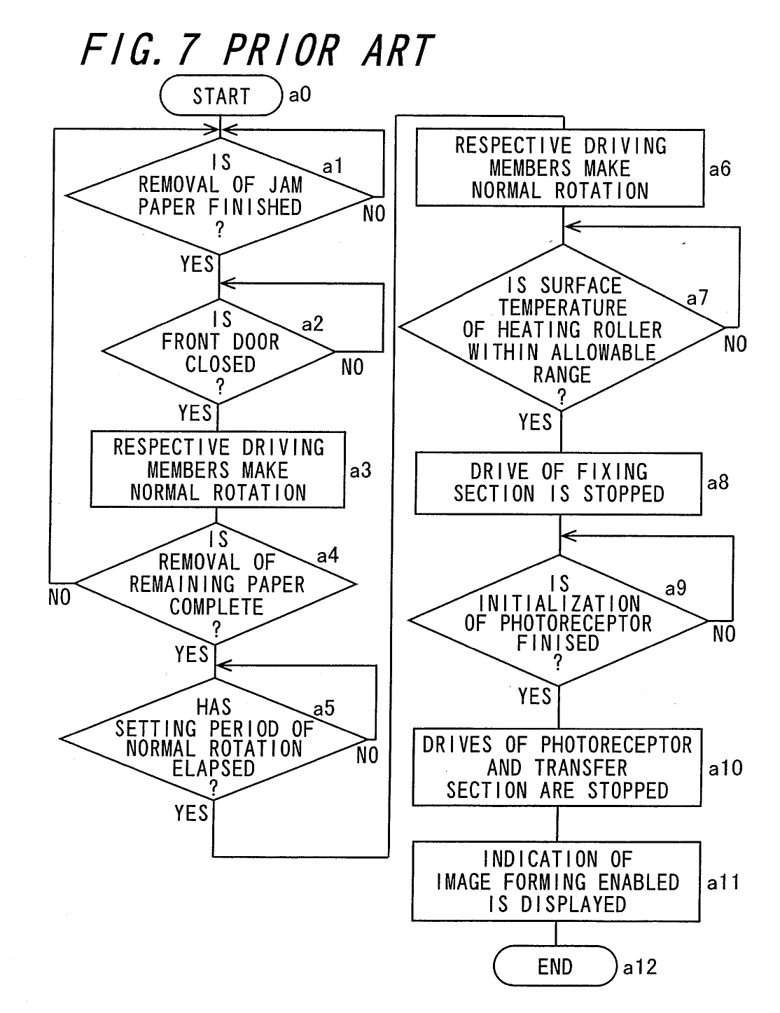

In Step s7, the control section gives the drive section a normal drive instruction and makes the respective driven members normally rotate. In this step, the respective driven members make the normal rotational drive at a rotation speed S₂ of which value is the same as the rotation speed during image formation as shown in FIG. 6. This makes it possible to adjust the nip width of the nip of the respective driven members. Accordingly, the adjustment makes it possible to restrain a wrinkle from occurring on the recording paper conveyed on the paper conveyance path 71 when the action of forming the image on the recording paper is restarted after the restarting action of the apparatus is finished. Therefore, the deterioration in quality of the image formed on the recording paper caused by the wrinkle on the recording paper and recurrence of the paper jam can be restrained.

In Step s8, a signal indicating whether the predetermined setting period of the normal rotation has elapsed is given to the control section, and the step proceeds to Step s9 when the control section judges that the predetermined setting period of rotation has elapsed. When the control section judges that the setting period of rotation does not elapse, Step s8 is repeated until the setting period elapses. In Step s9, the control section gives the drive section an instruction to stop conveying and stops the rotation of the conveyance section 7. Then, the rotation speed of the conveyance section 7 becomes zero, as shown in FIG. 3. Next, in Step s10, a signal indicating whether surface temperature of the heating roller 61 is within an allowable range or not is given to the control section by the fixing section 6, and the step proceeds to Step s11 when the control section judges that the surface temperature is within the allowable range. In Step s10, when the control section judges that the surface temperature of the heating roller 61 is not within the allowable range, Step s10 is repeated until the surface temperature of the heating roller 61 becomes within the allowable range.

In Step s11, the control section gives the drive section an instruction to stop fixing, and stops rotation of the fixing section 6. Then, the rotation speed of the fixing section 6 becomes zero as shown in FIG. 3. Next, in Step s12, a signal indicating whether initialization of the photoreceptor 3 is made or not is given to the control section by the photoreceptor 3, and the step proceeds to Step s13 when the control section judges that the initialization of the photoreceptor 3 is made. In Step s12, when the control section judges that the initialization of the photoreceptor 3 is not made, Step s12 is repeated until the initialization of the photoreceptor 3 is made. In Step s13, the control section gives the drive section an instruction to stop rotation of the photoreceptor and transferring, and stops rotation of the photoreceptor 3 and the transfer section 10. Then, the rotation speed of the photoreceptor 3 and the transfer section 10 becomes zero as shown in FIG. 3. Next, in Step s14, the image forming apparatus 100 displays an indication showing that the image formation is enabled, the step proceeds to Step s15, and finishes the restarting action of the apparatus.

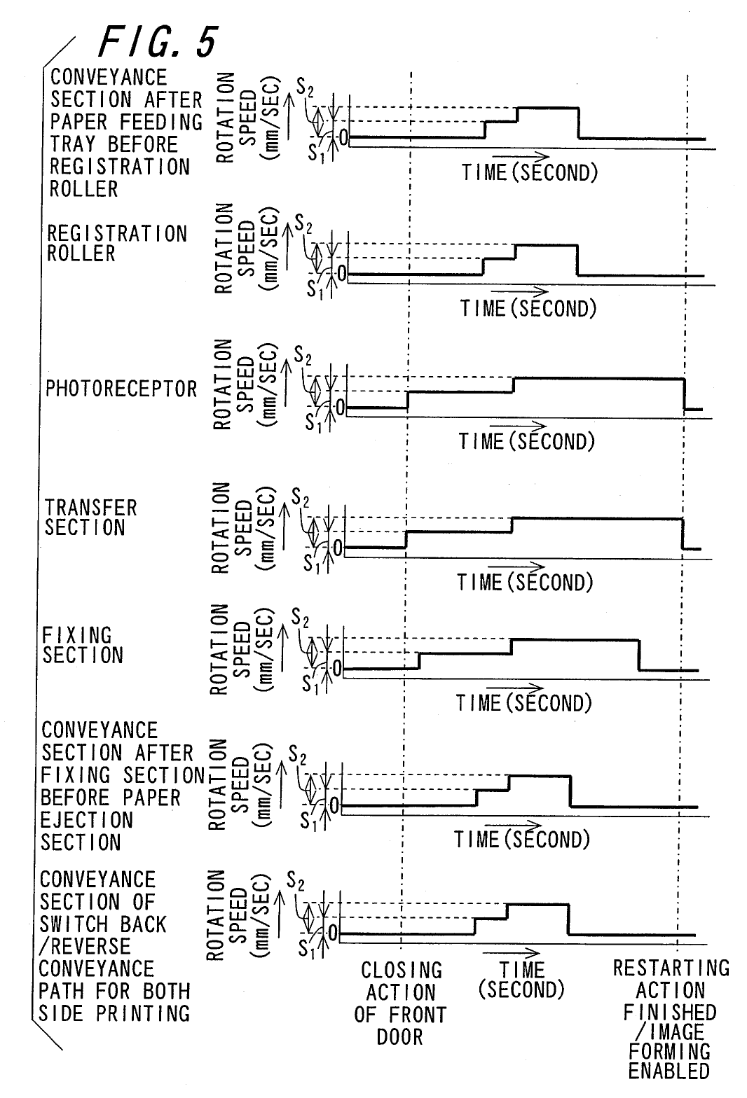

FIG. 5 is the view showing the timings of the changes in the rotation speeds of the respective driven members at the time of restarting the apparatus in the second embodiment of the invention. The second embodiment of the invention is the same as the first embodiment of the invention except for a point that timings for starting the low-speed rotation of the respective driven members are staggered in accordance with the outer circumferential length of the respective driven members such as the photoreceptor 3, the fixing section 6, the conveyance section 7, transfer section 10 and the registration roller 11. In the second embodiment of the invention, the followings are described only about the timings of starting the low-speed rotation of the respective driven members. In the second embodiment of the invention, firstly, the driven members such as the photoreceptor 3 and the transfer section 10 of which outer circumferential length is large start to make the low-speed rotation at the rotation speed S₁ as shown in FIG. 5. Secondly, the driven members such as the fixing section 6 starts to make the low-speed rotation. And then, the driven members such as the conveyance section 7 and the registration roller 11 of which outer circumferential length is small start to make the low-speed rotation.

As described above, when all of the respective driven members finish rotating once at the same time by staggering the timings of starting the low-speed rotation of the respective driven members in accordance with the outer circumferential length of the respective driven members, the respective detecting sections can finish detecting drive load. Since the detection of the drive load is finished when all of the driven members rotate only once, the occurrence of the flaw on the surface of the driven members can be suppressed even when the jammed paper sheet is tangled up in the driven members.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An image forming apparatus comprising:
an image bearing member which bears an electrostatic latent image thereon;
a transfer section which supplies toner to the electrostatic latent image formed on the image bearing member and transfers a toner image onto a transfer material;
a fixing section which fixes the toner image formed on the transfer material;
a conveyance section which conveys the transfer material to the fixing position;
a drive section which drives driven members including the image bearing member, the transfer section, the fixing section and the conveyance section; and
a drive load detecting section which detects drive load of the respective driven members driven by the drive section,
the drive section stopping drives of the respective driven members at a time when the drive load detecting section detects a drive load of which value is greater than or equal to a predetermined load value, when a predetermined condition is fulfilled.

2. The image forming apparatus of claim 1, further comprising a transfer material existence detecting section which detects presence or absence of the transfer material on a paper conveyance path on which the conveyance section conveys the transfer material,
wherein the drive section stops driving of the respective driven members by the drive section when the drive load detecting section detects the drive load of which value is greater than or equal to the predetermined load value and the transfer material existence detecting section detects the transfer material at the time of restarting the apparatus.

3. The image forming apparatus of claim 1, wherein, in rotation speeds of the respective driven members rotated by the drive section, the rotation speed when the drive load detecting section detects the drive load and when the transfer material existence detecting section detects the transfer material is smaller than the rotation speed when the image is formed on the transfer material.

4. The image forming apparatus of claim 1, wherein the drives of the respective driven members by the drive section are stopped and a warning is displayed when the drive load detecting section detects the drive load of which value is greater than or equal to the predetermined value and when the transfer material existence detecting section detects the transfer material at the time of restarting the apparatus.

5. The image forming apparatus of claim 1, wherein detection actions of the drive load detecting section and the transfer material existence detecting section in a state where a predetermined condition is fulfilled are taken at a time of warm-up when energization to the apparatus restarts and at a time of recovery from power saving mode after the jam treatment is made by removing the remaining transfer material on a paper conveyance path.

6. A method of restarting the image forming apparatus which forms the image by transferring the toner image formed on the image bearing member on the transfer material, comprising:
a drive load detection step of detecting drive load of a plurality of rotating driven members; and
a transfer material existence detection step of detecting presence or absence of the transfer material on a paper conveyance path on which the transfer material is conveyed.

7. The method of claim 6, wherein the rotation speeds of the respective driven members in the drive load detection step and the transfer material existence detection step are smaller than the rotation speeds of the respective driven members when the image is formed on the transfer material.

8. The method of claim 6, wherein a rotation speed during detection is set to be half or lower than a rotation speed during image formation.

9. The method of claim 6, wherein a setting period of the drive load detection step and the transfer material existence detection step is set to a period during which all of the plurality of driven members finish rotating once.
